(19) United States
(12) Patent Application Publication
(10) Pub. No.: US 2018/0145800 A1
(43) Pub. Date: May 24, 2018

(54) METHOD OF REDUCING POWER CONSUMPTION IN USER EQUIPMENT

(71) Applicant: Samsung Electronics Co., Ltd., Suwon-si (KR)

(72) Inventors: Ankit SRIVASTAV, Bangalore (IN); Rohan Raj, Bangalore (IN)

(73) Assignee: Samsung Electronics Co., Ltd., Suwon-si (KR)

(21) Appl. No.: 15/685,647

(22) Filed: Aug. 24, 2017

(30) Foreign Application Priority Data
Nov. 24, 2016 (IN) 201641040275

(51) Int. Cl. H04L 1/18; H04W 52/02; H04W 56/00; H04L 5/00; H04W 72/04; H04W 74/08

(52) U.S. Cl. CPC H04L 1/1883; H04W 52/0229; H04W 56/001; H04W 72/1289; H04W 72/0413; H04W 74/0833; H04W 72/042; H04L 5/0048

(57) ABSTRACT

A method of reducing power consumption in a user equipment (UE) including receiving, by the UE, a discontinuous reception (DRX) configuration from an evolved node B (eNB) when the UE is in radio resource control (RRC) connected state with the eNB, determining, by the UE, whether any uplink (UL) Hybrid Automatic Repeat Request (HARQ) transmission is pending for the DRX configured UE, the DRX configured UE being the UE configured by the DRX configuration, determining whether Physical Downlink Control Channel (PDCCH) monitoring mask is defined in the DRX configuration if any UL HARQ transmission is pending for the DRX configured UE, and monitoring PDCCH only on discrete occasions at which UL grant is expected from eNB if the PDCCH monitoring mask is included in the DRX configuration may be provided.

### PRIORITY

This application claims priority under 35 U.S.C. § 119(a) to Indian Complete Patent Application Serial No. 201641040275 (CS), which was filed on Nov. 24, 2016 in the Indian Intellectual Property Office, the entire disclosure of this application is incorporated herein by reference.

### BACKGROUND

### 1. Field

The present inventive concepts generally relate to wireless communications, and more particularly to methods of reducing power consumption in a user equipment.

### 2. Description of the Related Art

In order to avoid fast battery drainage in a user equipment (UE) associated with a Long Term Evolution (LTE) network, the LTE network system utilizes discontinuous reception (DRX) operation. The DRX operation allows UE to save battery power over the period of time when UE is inactive. The DRX operates in both Idle and Connected mode. In Idle mode DRX operation, the UE saves battery power autonomously in between the paging occasions where network is expected to send the paging messages to the UE. In connected mode DRX (e.g., connected DRX) operation, the power saving in UE is controlled by network provided timers and data transmission status at both UE and the network. FIG. 1 illustrates an example of the connected mode DRX cycle.

As per 3GPP, when UE is in RRC_CONNECTED state, the eNB provides DRX configurations to UE as shown in FIG. 2. If DRX is configured, UE monitors Physical Downlink Control Channel (PDCCH) discontinuously. Otherwise it will monitor the PDCCH continuously. The operation of DRX is controlled by Radio Resource Control (RRC) by configuring DRX parameters such as on Duration Timer (ODT), drx-Inactivity Timer (IAT), DRX-Retransmission Timer (RTT), the long DRX-Cycle, the value of the drx Start Offset and optionally the drx Short Cycle Timer and short DRX-Cycle. A Hybrid Automatic Repeat Request Round Trip Time (HARQ RTT) timer per downlink (DL) HARQ process is also defined. The definitions of different DRX parameters are described below.

The on Duration Timer refers to the number of consecutive PDCCH-subframe(s) at the beginning of the DRX Cycle, which refers to the periodic repetition of the On Duration followed by a possible period of inactivity.

The drx-Inactivity Timer refers to the number of consecutive PDCCH-subframe(s) after the subframe in which a PDCCH indicates an initial uplink or downlink (UL or DL) user data transmission for the MAC entity.

The HARQ RTT Timer refers to the minimum amount of subframe(s) before a DL HARQ retransmission is expected by the MAC entity.

The DRX-Retransmission Timer refers to the maximum number of consecutive PDCCH-subframe(s) until a DL retransmission is received.

So, when a DRX cycle is configured, the active time includes the time while any of the timers such as on Duration Timer, drx-Inactivity Timer, DRX-Retransmission Timer and mac-Contention Resolution Timer is running; or a scheduling request sent on Physical Uplink Control Channel (PUCCH) is pending; or an uplink grant for a pending HARQ retransmission can occur and data can exist in the corresponding HARQ buffer; or a PDCCH indicating a new transmission addressed to a cell radio network temporary identifier (C-RNTI) of the MAC entity has not been received after successful reception of a Random Access Response for the preamble that is not selected by the MAC entity.

FIG. 3 is a schematic diagram illustrating an example of the Connected DRX operation when no Uplink transmission is ongoing, according to the related art. At the start of each DRX cycle, UE starts On Duration Timer (ODT) and monitors the PDCCH continuously. As shown in FIG. 3, when a PDCCH is received, a drx-Inactivity Timer (IAT) is started, and when all the running timers expired, the UE stops monitoring PDCCH and goes in to power saving mode till the start of next DRX cycle.

FIG. 4 is another schematic diagram illustrating an example of the connected DRX operation in which PDCCH for uplink grant is received during on-duration time, according to the related art. When UE performs any uplink transmission during the DRX active period, a DRX-inactivity timer is started and the UE expects an ACK/NACK message from a network. Further, the UE keeps transmitting data stored in its buffer (HARQ buffer) if NACK is received, and thus the data is desired to be retransmitted. So, the UE cannot go under DRX even after drx-Inactivity Timer is expired because data in HARQ buffer is still pending for retransmission.

As per the related art, because of the unreliability of ACK/NACK decoding, even upon receiving an ACK from the eNB, data in HARQ buffer is not flushed and the UE would continue to be in a wake-up state until an uplink (UL) grant with new data indicator (NDI) toggled is received, or T (HARQ RTT*max HARQ-Tx) ms is elapsed. Hence, even if ODT and IAT have been expired, UE cannot enter into a power saving mode. For example, in a case where HARQ RTT is 8 ms and max HARQ-T is 4, the PDCCH monitoring period can be 32 ms which can be longer than a short DRX cycle value, or constitute a substantial portion of along DRX cycle.

Therefore, in scenarios where network does not want to send any other data, the current behavior of UE leads to significant power wastage in PDCCH decoding because UL HARQ in LTE is synchronous (meaning that there are only specific time instants when uplink grant for pending HARQ retransmission can occur). Because UE and eNB both are aware about specific subframes where any uplink grant for pending HARQ retransmission can occur, monitoring PDCCH at other times is not desirable.

Currently, there exists no solution to control monitoring of PDCCH effectively in order to save power in the above-mentioned scenario. Thus, a novel method for reducing power consumption in a cellular device is desired.

The above-mentioned shortcomings, disadvantages and problems will be more fully understood by reading and studying the following disclosure of specification.

### SUMMARY

Various example embodiments herein describe methods of reducing power consumption in a user equipment (UE). According to one example embodiment, the method may include receiving, by the UE, a discontinuous reception (DRX) configuration from an evolved node B (eNB) when the UE is in radio resource control (RRC) connected state with the eNB, determining, by the UE, whether any uplink (UL) Hybrid Automatic Repeat Request (HARQ) transmission is pending for the DRX configured UE, the DRX configured UE being the UE configured by the DRX configuration, determining whether Physical Downlink Control Channel (PDCCH) monitoring mask is defined in the DRX configuration if any UL HARQ transmission is pending for the DRX configured UE, monitoring PDCCH only on discrete occasions at which UL grant is expected from eNB if the PDCCH monitor masking is included in the DRX configuration.

According to one example embodiment, the receiving receives the PDCCH monitoring mask the UE through radio resource control (RRC) signaling message.

According to another example embodiment, the receiving receives the PDCCH monitor mask through Layer-2 messaging as a medium access control (MAC) element of layer 2 of the UE.

According to another example embodiment, the receiving receives the PDCCH monitor mask Layer-2 messaging as a by sending a PDCCH with at least one of a specific bit pattern or a specific DCI format.

According to another example embodiment, the receiving includes receiving the DRX configuration, which includes the PDCCH monitoring mask that is dynamically configured and released by the eNB, based on data traffic at the UE.

Various example embodiments herein further describe a user equipment (UE) for reducing power consumption. According to one example embodiment, the UE may include a transceiver configured to receive a discontinuous reception (DRX) configuration from an evolved node B (eNB) when the UE is in radio resource control (RRC) connected state with the eNB, a processor configured to determine whether any uplink (UL) Hybrid Automatic Repeat Request (HARQ) transmission is pending, and determining whether Physical Downlink Control Channel (PDCCH) monitoring mask is defined in the DRX configuration if any UL HARQ transmission is pending for the DRX configured UE, and a memory including a Physical downlink control channel (PDCCH) monitor masking module, the PDCCH monitor masking module configured to monitor PDCCH only on discrete occasions at which UL grant is expected from eNB if the PDCCH monitoring mask is defined in the DRX configuration.

According to one example embodiment, a method of reducing power consumption in a user equipment (UE) may include receiving, by the UE, a discontinuous reception (DRX) configuration from an evolved node B (eNB) when the UE is in radio resource control (RRC) connected state with the eNB, determining whether Physical Downlink Control Channel (PDCCH) monitoring mask is defined in the DRX configuration if any UL HARQ transmission is pending for the DRX configured UE, the DRX configured UE being the UE configured by the DRX configuration, and one of waking up the UE at discrete occasions at which UL grant is expected from eNB, or entering the UE into a power saving mode in other occasions based on the PDCCH monitoring mask

The foregoing has outlined, in general, the various aspects of the inventive concepts and is to serve as an aid to better understand the more complete detailed description which is to follow. In reference to such, there is to be a clear understanding that the present inventive concepts are not limited to the method or application of use described and illustrated herein. Any other advantages and objects of the present inventive concepts will become apparent or obvious from the detailed description or illustrations contained herein.

### BRIEF DESCRIPTION OF THE DRAWINGS

The other objects, features and advantages will occur to those skilled in the art from the following description of some example embodiment and the accompanying drawings in which:

FIG. 1 is a schematic diagram illustrating an example connected DRX cycle, according to the related art.

FIG. 2 is a schematic diagram illustrating an example reception of DRX parameters from a network, according to the related art.

FIG. 3 is a schematic diagram illustrating an example Connected DRX operation when no Uplink transmission is ongoing, according to the related art.

FIG. 4 is another schematic diagram illustrating an example connected DRX operation in which PDCCH for uplink grant is received during on-duration time, according to the related art.

FIG. 5 is a flowchart diagram illustrating a method of reducing power consumption in a user equipment, according to one example embodiment.

FIGS. 6A and 6B are schematic diagrams illustrating example monitoring of PDCCH using DRX operation to save power in a user equipment, according to one example embodiment.

FIG. 7 is a block diagram illustrating one or more components of a user equipment (UE)

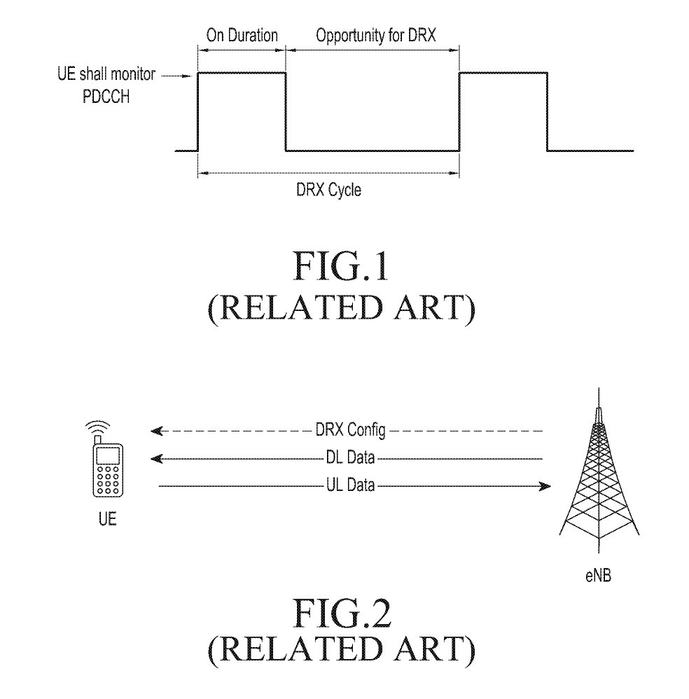

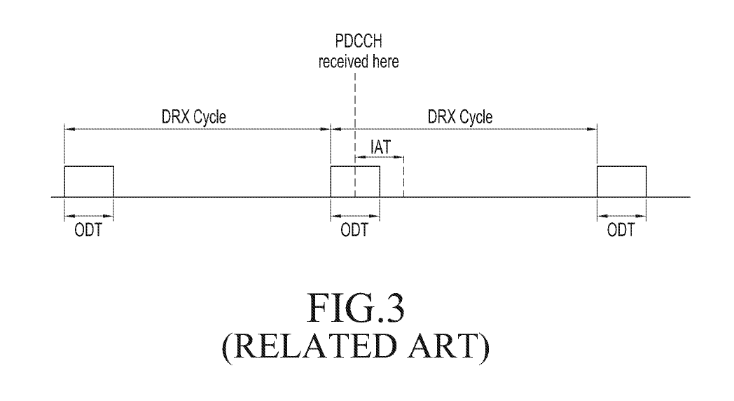

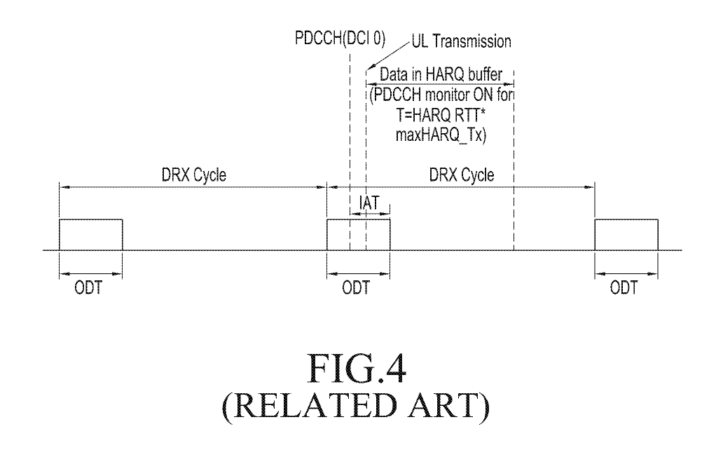

Although specific features of the present inventive concepts are shown in some drawings and not in others, this is done for convenience only as each feature may be combined with any or all of the other features in accordance with the present inventive concepts.

### DETAILED DESCRIPTION

The various example embodiments of the present inventive concepts disclose a method for reducing power consumption in a user equipment. In the following detailed description of the example embodiments of the inventive concepts, reference is made to the accompanying drawings that form a part hereof, and in which are shown by way of illustration specific example embodiments in which the inventive concepts may be practiced. These example embodiments are described in sufficient detail to enable those skilled in the art to practice the inventive concepts, and it is to be understood that other example embodiments may be utilized and that changes may be made without departing from the scope of the present inventive concepts. The following detailed description is, therefore, not to be taken in a limiting sense, and the scope of the present inventive concepts is defined only by the appended claims.

The specification may refer to “an”, “one” or “some” example embodiment(s) in several locations. This does not necessarily imply that each such reference is to the same example embodiment(s), or that the feature only applies to a single example embodiment. Single features of different example embodiments may also be combined to provide other example embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features, integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present inventive concepts provide methods of reducing power consumption in a user equipment. Various example embodiments are described in the present disclosure to describe the working of the method, but not limiting to the scope of the present inventive concepts.

Example embodiments and the various features and advantages details thereof are explained more fully with reference to the non-limiting example embodiments that are illustrated in the accompanying drawings and detailed in the following description. Descriptions of well-known components and processing techniques are omitted so as to not unnecessarily obscure the example embodiments herein. The examples used herein are intended merely to facilitate an understanding of ways in which the example embodiments herein can be practiced and to further enable those of skill in the art to practice the example embodiments herein. Accordingly, the examples should not be construed as limiting the scope of the example embodiments herein.

The present inventive concepts may use a PDCCH monitoring mask for reducing power consumption in a user equipment. This PDCCH monitoring mask may be added as a new field and provided to UE as part of DRX-Configuration, which is received through radio resource control (RRC) signaling. The PDCCH monitoring mask can be enabled or disabled. When the PDCCH monitoring mask is enabled, the UE may be controlled to not monitor PDCCH during the entire duration for which uplink (UL) HARQ buffer has data in it. Rather, the UE may be controlled to monitor PDCCH only at specific subframes where UL grant for a pending HARQ retransmission occurs. This may lead to discrete PDCCH monitoring using DRX operation.

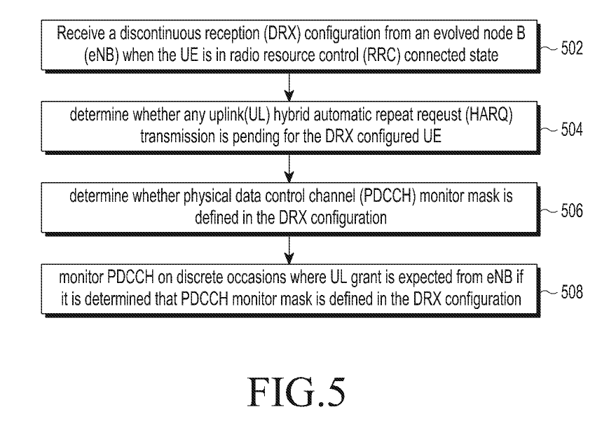

FIG. 5 is a flowchart diagram illustrating a method of reducing power consumption in a user equipment (UE), according to one example embodiment. A UE can establish a radio resource control (RRC) connection with a network (e.g., an evolved node B (eNB)), by performing RRC connection establishment procedure. Upon successfully establishing the RRC connection, the eNB may transfer discontinuous reception (DRX) operation parameters along with Physical downlink control channel (PDCCH) monitoring mask to the UE via RRC signaling message. In one example embodiment, the PDCCH monitoring mask can be set through Layer-2 messaging as a medium access control (MAC) Control element. The MAC control element with new Logical Channel Identity (LCID) may be used to indicate configuration for PDCCH monitoring mask. In another example embodiment, PDCCH monitoring mask can be set through Layer-1 messaging by sending a PDCCH with specific bit pattern/DCI format.

The UE configured with PDCCH monitoring mask may disable PDCCH monitoring procedures in associated hardware and/or software to save power. The step by step procedure in reducing power consumption in a UE is explained as follows. At step 502, a DRX configuration from an evolved node B (eNB) may be received when the UE is in radio resource control (RRC) connected state with the eNB. At step 504, the UE may determine whether any uplink (UL) hybrid automatic repeat request (HARQ) transmission is pending. If the UL HARQ transmission is ongoing, at step 506, the UE may further determine whether a PDCCH monitoring mask is defined in the DRX configuration. If no UL HARQ transmission is pending, then the UE may perform normal DRX operation. If PDCCH monitoring mask is defined, then at step 508, the UE may monitor PDCCH at discrete occasions where a UL grant is expected from the eNB. Hence, the UE monitor may wake up at the discrete occasions to monitor the PDCCH channel. In all other occasions, the UE may enter into a power saving mode. Thus, the present inventive concepts may save power (e.g., reduce power consumption) in the UE using the PDCCH monitoring mask. In one example embodiment, the UE may be at least one of a mobile device, a smart phone, a personal data assistant (PDA), a laptop, a netbook, or any other device capable of wireless communication.

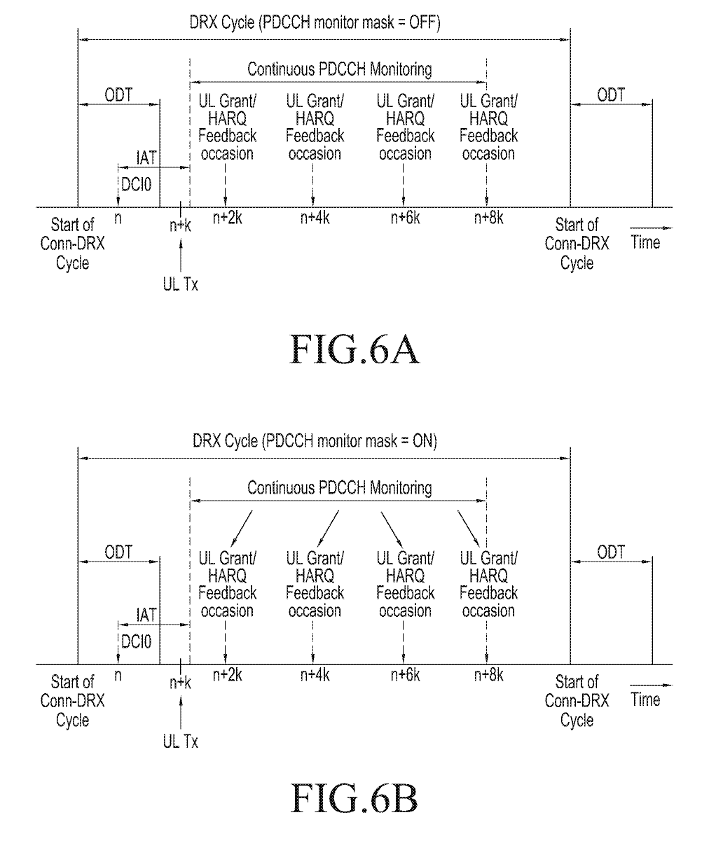

FIGS. 6A and 6B are schematic diagrams illustrating example monitoring of physical downlink control channel (PDCCH) using discontinuous reception (DRX) operation to save power in a user equipment (UE), according to one example embodiment. FIG. 6A illustrates an operation of a UE when PDCCH monitoring mask is set OFF and FIG. 6B illustrates an operation of the UE when PDCCH monitoring mask is set ON. FIG. 6A illustrates a case where the UE receives an uplink (UL) grant as a downlink control information (DCIO) at a time period ‘n,’ and makes an uplink transmission at time period n+k; and the PDCCH monitoring mask is set OFF. When the PDCCH monitoring mask is set OFF, the UE performs monitoring PDCCH as per current procedure. As such, the total time for the UE to monitor the PDCCH may be calculated by:

HARQ RTT*max HARQ-Tx

Where HARQ RTT refers to the minimum amount of subframe(s) before a DL HARQ retransmission is expected by the MAC entity, and

max HARQ-Tx represents the maximum number of HARQ transmissions

Let us assume that k=4 for frequency division duplex (FDD), and value of max HARQ-Tx=4), then UE may have to monitor the PDCCH continuously for about 28 ms. Thus, a considerable amount of power may be wasted in the UE.

However, as shown FIG. 6B, if the PDCCH monitoring mask is set ON, then for the same values of UE with k=4 for frequency division duplex (FDD), and value of max HARQ-Tx=4), the UE may have to monitor PDCCH for only 4 occasions for a period of 4 ms. Thus, comparing with the time for decoding PDCCH in FIG. 6A (e.g., when PDCCH monitoring mask is set OFF), the time for decoding PDCCH in FIG. 6B (e.g., when PDCCH monitoring mask is set ON) may be about 85% less. Overall power saving becomes more significant when UE is making frequent UL transmissions separated by regular intervals as in the case of semi persistent scheduling (SPS).

The present inventive concepts may reduce the PDCCH monitoring time, and thus saves power without affecting DL data reception in various operation scenarios. For example, if network wants to send any DL data in burst, it may not need to wait for the start of the next DRX cycle. The network may send the first transmission on one of the UL grant occasions, and subsequent DL data may be scheduled continuously when DRX-InactivityTimer/DRX-Retransmission Timer start running. Hence, by defining the PDCCH monitoring mask, the DL responsiveness may not be affected. In another example, if network wants to send DL at regular intervals, as in semi persistent scheduling (SPS), the network may keep DL SPS occasions to be aligned with the On Duration Timer only and hence the new feature TDCCH monitoring mask’ may not affect this case as well.

Thus, monitoring PDCCH mask may not negatively impact the legacy DRX scheme in any case. If network has any PDCCH data to send dynamically, then the network may schedule initial PDCCH on the UL grant occasions and schedule subsequent PDCCHs during the time when drx-Inactivity Timer is running. The present inventive concepts do not affect the UL/DL channel estimation as well even when the PDCCH monitoring mask is enabled. The UE can still be configured by network to continuously keep sending channel state information (CSI) or Sounding Reference Signal (SRS) as those procedures are not dependent on PDCCH monitoring. The network can configure/re-configure an appropriate value of drx-Inactivity Timer depending on the data requirement. Further, the network may also have flexibility to configure/release PDCCH mask depending upon data requirement.

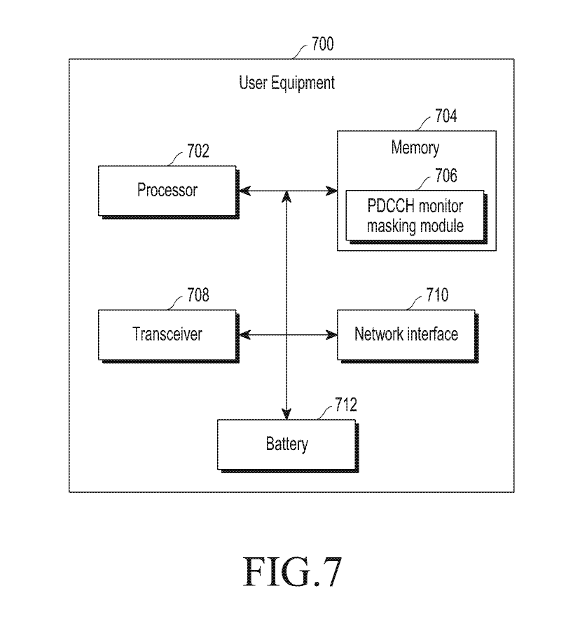

FIG. 7 is a block diagram illustrating one or more components of a user equipment (UE) 700 as shown in FIG. 2, according to one example embodiment. According to this example embodiment, the UE 700 may include a processor 702, a memory 704, a PDCCH monitor masking module 706, a transceiver 708, a network interface 710 and a battery 712.

The processor 702 may process information and execute instructions or operations. The Processor 702 may be any type of general or specific purpose processor. While a single processor is shown in FIG. 7, multiple processors may be utilized according to other example embodiments.

The memory 704 may be coupled to processor 702 and store information and instructions to be executed by processor 702. The Memory 704 can be comprised of any combination of random access memory (“RAM”), read only memory (“ROM”), static storage such as a magnetic or optical disk, or any other type of non-transitory machine or computer readable media. The memory 704 may include PDCCH monitor masking module for reducing power consumption in the UE. When set ON, the PDCCH monitor masking module 706 may enable the UE to discretely monitoring PDCCH channel at desired (or alternatively, predefined) occasions to save power. When set OFF, the PDCCH monitor masking module 706 may enable the UE to monitor PDCCH channel continuously.

The transceiver 708 may transmit or receive information, such as data and/or control signals. In some examples, the receiver and transmitter functionality of the transceiver 708 may be implemented in different units. In one example embodiment, the receiver functionality may be implemented by a receiver, which is configured to receive uplink grant from a network, and the transmitter functionality may be implemented by the transceiver, which is configured to transmit data from UE to the network. The transceiver may be connected to a RF antenna (not shown in FIG. 7). The RF antenna may enable communication between the UE and the network.

The network interface 710 may enable the UE to communicate with a network or with another UEs present in the network. All call notifications and/or messages are received via, for example, the network interface 710. The battery 712 is adapted for providing power to the entire circuit.

In the following detailed description of the example embodiments of the inventive concepts, reference is made to the accompanying drawings that form a part hereof, and in which are shown by way of illustration specific example embodiments in which the inventive concepts may be practiced. These example embodiments are described in sufficient detail to enable those skilled in the art to practice the inventive concepts, and it is to be understood that other example embodiments may be utilized and that changes may be made without departing from the scope of the present inventive concepts. The following detailed description is, therefore, not to be taken in a limiting sense, and the scope of the present inventive concepts is defined only by the appended claims.

What is claimed is:

1. A method of reducing power consumption in a user equipment (UE), the method comprising:
receiving, by the UE, a discontinuous reception (DRX) configuration from an evolved node B (eNB) when the UE is in radio resource control (RRC) connected state with the eNB;
determining, by the UE, whether any uplink (UL) Hybrid Automatic Repeat Request (HARQ) transmission is pending for the UE;
determining whether Physical Downlink Control Channel (PDCCH) monitoring mask is included in the DRX configuration if any UL HARQ transmission is pending for the UE; and
monitoring PDCCH only on discrete occasions at which UL grant is expected from eNB if the PDCCH monitoring mask is included in the DRX configuration.

2. The method as claimed in claim 1, wherein the receiving receives the PDCCH monitoring mask through a radio resource control (RRC) signaling message.

3. The method as claimed in claim 1, wherein the receiving receives the PDCCH monitoring mask through Layer-2 messaging as a medium access control (MAC) element.

4. The method as claimed in claim 1, wherein the receiving receives the PDCCH monitoring mask as Layer-1 messaging by sending a PDCCH with at least one of a specific bit pattern or a specific DCI format.

5. The method as claimed in claim 1, wherein the receiving comprises receiving the DRX configuration, the DRX configuration including the PDCCH monitoring mask that is dynamically configured and released by the eNB based on data traffic at the UE, from the eNB.

6. The method as claimed in claim 1, wherein the monitoring comprises waking up the UE at the discrete occasion to monitor the PDCCH.

7. The method as claimed in claim 6, wherein the waking up is performed if the PDCCH monitoring mask is set ON.

8. A user equipment (UE) comprising:
a transceiver configured to
receive a discontinuous reception (DRX) configuration from an evolved node B (eNB) when the UE is in radio resource control (RRC) connected state with the eNB;
a processor configured to
determine whether any uplink (UL) Hybrid Automatic Repeat Request (HARQ) transmission is pending; and
determine whether Physical Downlink Control Channel (PDCCH) monitoring mask is defined in the DRX configuration if any UL HARQ transmission is pending for the DRX configured UE; and
a memory including a Physical downlink control channel (PDCCH) monitor masking module, the PDCCH monitor masking module configured to:
monitor PDCCH only on discrete occasions at which UL grant is expected from eNB if the PDCCH monitoring mask is defined in the DRX configuration.

9. The user equipment as claimed in claim 8, wherein the transceiver configured to receive the PDCCH monitoring mask through a radio resource control (RRC) signaling message.

10. The user equipment as claimed in claim 8, wherein the transceiver configured to receive the PDCCH monitoring mask through Layer-2 messaging as a medium access control (MAC) element.

11. The user equipment as claimed in claim 8, wherein the transceiver configured to receives the PDCCH monitoring mask as Layer-1 messaging by sending a PDCCH with at least one of a specific bit pattern or a specific DCI format.

12. The user equipment as claimed in claim 8, wherein the transceiver configured to receive the DRX configuration, the DRX configuration including the PDCCH monitoring mask that is dynamically configured and released by the eNB based on data traffic at the UE, from the eNB.

13. The user equipment as claimed in claim 8, wherein the PDCCH monitor masking module is configured to wake up the UE at the discrete occasion to monitor the PDCCH.

14. The user equipment as claimed in claim 13, wherein the PDCCH monitor masking module is configured to wake up the UE if the PDCCH monitoring mask is set ON.

15. A method of reducing power consumption in a user equipment (UE), the method comprising:
receiving, by the UE, a discontinuous reception (DRX) configuration from an evolved node B (eNB) when the UE is in radio resource control (RRC) connected state with the eNB;
determining whether Physical Downlink Control Channel (PDCCH) monitoring mask is included in the DRX configuration if any UL HARQ transmission is pending for the UE; and
waking up the UE at discrete occasions at which UL grant is expected from eNB based on the PDCCH monitoring mask.

16. The method as claimed in claim 15, wherein the waking up is performed if the PDCCH monitoring mask is set ON.

17. The method as claimed in claim 15, wherein the receiving receives the PDCCH monitoring mask through a radio resource control (RRC) signaling message.

18. The method as claimed in claim 15, wherein the receiving receives the PDCCH monitoring mask through Layer-2 messaging as a medium access control (MAC) element.

19. The method as claimed in claim 15, wherein the receiving receives the PDCCH monitoring mask as Layer-1 messaging by sending a PDCCH with at least one of a specific bit pattern or a specific DCI format.

20. The method as claimed in claim 15, wherein the receiving includes receiving the DRX configuration, which includes the PDCCH monitoring mask dynamically configured and released by the eNB based on data traffic at the UE, from the eNB.
